(19) United States
(12) Patent Application Publication
(10) Pub. No.: US 2009/0083798 A1
(43) Pub. Date: Mar. 26, 2009

(54) METHOD AND SYSTEM FOR PROVIDING PROGRAM GUIDE SERVICE

(75) Inventor: Ji-Young LEE, Seoul (KR)

Correspondence Address: EDWARDS ANGELL PALMER & DODGE LLP, P.O. BOX 55874, BOSTON, MA, 02205, US

(73) Assignee: ALTICAST CORPORATION, Seoul (KR)

(21) Appl. No.: 12/234,654

(22) Filed: Sep. 20, 2008

(30) Foreign Application Priority Data
Sep. 20, 2007 (KR) 10-2007-0096164

(51) Int. Cl. H04N 5/445

(52) U.S. Cl. 725/46

(57) ABSTRACT

A method of providing program guide services in a broadcasting system coupled to at least one broadcasting terminal through a network includes: generating a video source for a program guide by processing a video signal for plural broadcasting programs; encoding the video source using a predetermined algorithm; and transmitting the encoded video source to the broadcasting terminal. The broadcasting terminal outputs the program guide including at least one of sub-videos included in the video source on the basis of audience rating/ranking.

### CROSS-REFERENCE TO RELATED APPLICATIONS

This application claims priority from Korean Patent Application No. 2007-96164 filed on Sep. 20, 2007, the contents of which are incorporated herein by reference in its entirety.

### TECHNICAL FIELD

The present disclosure relates to a method and a system for providing program guide service on the basis of user's preference information such as an audience rating.

### RELATED ART

Digital broadcasting services have been actively studied according as users require high definition broadcasting, an interactive broadcasting and various additional services.

Standardization of the digital broadcasting has been developed, including European digital video broadcasting-multimedia home platform (Hereinafter, referred to as “DVB-MHP”) and American advanced television systems committee-digital TV application software environment (Hereinafter, referred to as “ATSCDASE”).

With the development of the standardization of the digital broadcasting, a broadcasting signal having a video signal, an audio signal and a data signal can be compressed to a digital signal. As a result, multi-channel may be applied in TV broadcasting. In addition, various programs may be provided in one channel due to increase of transmission rating.

According as various applications have been developed, data broadcasting services are available, in which a broadcasting and data (additional information) related to the broadcasting are provided, such as weather service, news service, stock service, email service, electric program guide (EPG) service, TV shopping service, banking service, call service and Internet search service.

Through compression of the data, the data broadcasting may be provided with improved picture quality. However, the data broadcasting has a problem in that channel changing velocity becomes slower than that of the analog broadcasting due to a time for downloading broadcasting programs of a channel selected by a user or a time for loading applications for the data broadcasting, etc.

Users change channels using a channel up/down key. Many channels exist and the channel changing velocity is slow in the digital broadcasting. To enable a rapid channel search, most of digital broadcasting systems provide an EPG.

Typically, the digital broadcasting systems receive a video signal concerning a program broadcasted presently through an EPG generating section, process the video signal (e.g., converts the video signal to have small size), and provide the EPG in accordance with the processed result so that the user verifies easily video name and channel name concerning the program broadcasted presently and program information, etc.

The EPG is provided with mosaic type, and one EPG is usually made up of about twelve or sixteen sub-videos. Here, since one EPG has a limited number of sub-videos, the EPG is differently generated in accordance with broadcasting medium such as terrestrial broadcasting, satellite broadcasting, cable broadcasting. Different EPGs are respectively transmitted to a broadcasting terminal through different channels.

For example, in case that the EPG for the terrestrial broadcasting is provided, arrangement of broadcasting program may be changed. In this case, EPGs for the broadcasting programs should be generated, respectively.

Accordingly, in the conventional technique, loss of bandwidth is occurred according as the number of the channels provided to the user is increased. In addition, loss of bandwidth is occurred because many transmission channels are required to provide the EPSs arranged with various methods for the same broadcasting program.

In case that information concerning every broadcasting program is provided to the user, it is difficult for the user to select desired channel. Accordingly, selective information concerning a broadcasting program preferred by the user needs to be provided to the user.

### SUMMARY OF DISCLOSURE

Accordingly, the present invention is provided to substantially obviate one or more problems due to limitations and disadvantages of the related art.

One aspect of the present invention provides a method of providing program guide services in a broadcasting system coupled to at least one broadcasting terminal through a network, the method comprising: generating a video source for a program guide by processing a video signal for at least one broadcasting program; encoding the video source using a predetermined algorithm; and transmitting the encoded video source to the broadcasting terminal or terminals, wherein the broadcasting terminal or terminals output the program guide including at least one of sub-videos included in the video source on the basis of audience rating/ranking.

Another aspect of the present invention provides a method of providing program guide services to a broadcasting terminal which receives a broadcasting program from a broadcasting system through a network and displays the broadcasting program, the method comprising: receiving a video source for a program guide and information concerning audience rating/ranking, wherein the video source includes a plurality of sub-videos for plural broadcasting programs and is encoded in accordance with a preset algorithm; editing the sub-videos included in the video source by using the information concerning the audience rating/ranking; and generating the program guide including at least one of the edited sub-videos.

In still another aspect, the present invention provides a system for providing broadcasting services to at least one broadcasting terminal through a network, the system comprising: a video source generating section configured to generate a video source for a program guide by processing a video signal for at least one broadcasting program; a video source encoding section configured to encode the video source using a preset algorithm; an audience rating/ranking processing section configured to calculate audience rating/ranking through view information of a user or users transmitted from the broadcasting terminal or terminals; and an audience rating/ranking encoding section configured to encode information concerning the calculated audience rating ranking, wherein the broadcasting terminal or terminals output the program guide including at least one of sub-videos included in the video source on the basis of the information concerning the audience rating/ranking.

According to the present methods and systems, channel search efficiency can be enhanced and load of a headend terminal may be decreased.

The above and other aspects and features of the present invention will be discussed infra.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a broadcasting system according to one example embodiment of the present invention;

FIG. 2 is a block diagram illustrating a digital data broadcasting system according to one example embodiment of the present invention;

FIG. 3 is a block diagram illustrating a broadcasting terminal according to one example embodiment of the present invention;

FIG. 4 is a view illustrating a video source for program guide according to one example embodiment of the present invention;

FIG. 5 is a view illustrating a program guide according to one example embodiment of the present invention;

FIG. 6 is a view illustrating a program guide according to another example embodiment of the present invention;

FIG. 7 is a view illustrating a program guide according to still another example embodiment of the present invention;

FIG. 8 is a flowchart illustrating a process of providing program guide service according to one example embodiment of the present invention;

FIG. 9 and FIG. 10 are views illustrating a program guide according to still another example embodiment of the present invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

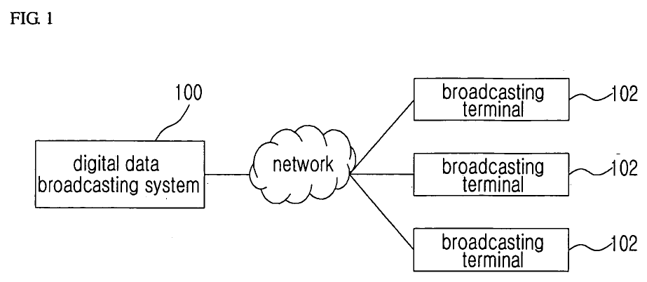

FIG. 1 is a block diagram illustrating a broadcasting system according to one example embodiment of the present invention.

In FIG. 1, the broadcasting system 100 is coupled to at least one broadcasting terminal 102 through a network. Here, the network includes, for example, a wire network having an Internet and an exclusive line, and a wireless network having a wireless Internet, a mobile communication network, a broadcasting network and a satellite communication network. Hereinafter, the network is assumed as the broadcasting network in that a broadcasting signal is provided through the network.

The broadcasting system 100 converts a video signal and an audio signal for broadcasting program of various channels into a proper format, and then transmits the converted signal to the broadcasting terminal 102.

In addition, the broadcasting system 100 performs a scheduling function about the broadcasting program and a scrambling function for blocking access of other people except a subscriber.

Furthermore, the broadcasting system 100 may include extra communication server, e.g. return path server for the purpose of processing requirement of a user through an uplink channel, and then provide Internet service and various communication service using the communication server.

The broadcasting system 100 provides a high definition broadcasting program compressed to digital. Hereinafter, the broadcasting system 100 is assumed as a digital data broadcasting system in that data service is provided through an application.

The digital data broadcasting system 100 may further provide data broadcasting application for use in various additional services and interactive service as well as the video signal/audio signal for a specific channel. Here, the data broadcasting application is formed by combining application for execution of a program with data corresponding to contents, e.g. is formed by combining the data received from news system, shopping system, stock system with the application.

The broadcasting terminal 102 performs tuning about a broadcasting signal transmitted from the digital data broadcasting system 100, and displays an image corresponding to the tuned broadcasting signal. Here, the broadcasting terminal 102 may be a set-top box coupled to a TV and for performing decoding of the broadcasting signal and the application, but is not limited as the set-top box. The broadcasting terminal 102 is not limited as specific terminal as long as the broadcasting terminal 102 provides a program guide on the basis of audience rating as described below.

The broadcasting terminal 102 processes the broadcasting program (video signal, audio signal and data signal) corresponding to a channel selected by the user of the tuned broadcasting signal, and then provides the processed broadcasting program to the user.

An operating system is set in the broadcasting terminal 102 so as to execute the application. Here, the operating system executes the application in case that the broadcasting signal has the data broadcasting application, thereby providing the data combined with the application to the user.

The application outputs an interface for request of a certain service by the user through a given display section, parses the data combined therewith in accordance with the request of the user, and outputs contents having the data such as text and graphic.

As described above, in case that the broadcasting terminal 102 provides the video signal converted into digital format and receives the data broadcasting application for additional service, much broadcasting standby time is required for selecting specific channel. Accordingly, the broadcasting terminal 102 provides a program guide so that the user may select easily a channel, thereby enabling the user to verify easily information concerning plural channels.

In one example embodiment of the present invention, the broadcasting terminal 102 monitors user's viewing history, and provides the program guide on the basis of the monitored result.

Particularly, the digital data broadcasting system 100 transmits video source for the program guide and audience rating/ranking information to the broadcasting terminal 102. Here, the video source includes a sub-video generated by processing video signals for broadcasting programs. The sub-video means a video signal generated by converting the video signal for the broadcasting programs transmitted from each of broadcasting stations to one with a smaller size, and is shown on a given area of the program guide outputted from the broadcasting terminal 102.

In addition, the sub-video may be a moving picture broadcasted in a corresponding channel. However, the sub-video is not limited as the moving picture, i.e. may be a still image of the corresponding channel.

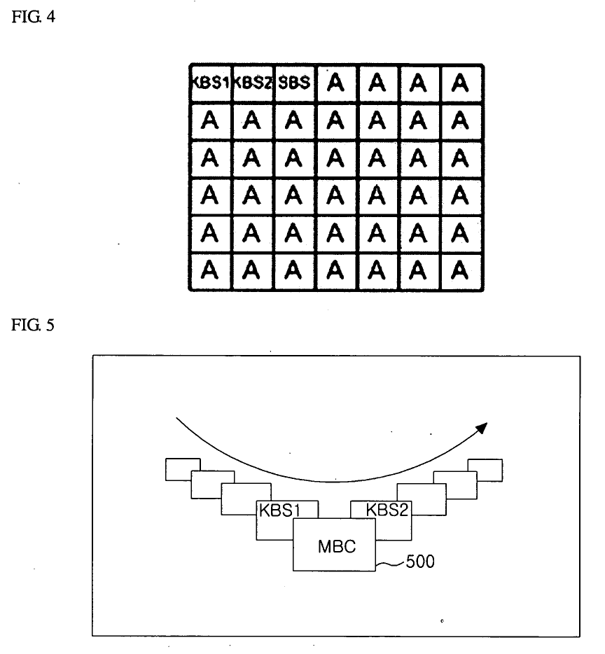

Preferably, the video source may include sub-videos for all or a portion of the broadcasting programs that can be provided to the broadcasting terminal 102, as shown in FIG. 4.

In one example embodiment of the present invention, the digital data broadcasting system 100 uses an encoding method in accordance with H.264 standard having high compression efficiency so as to encode the video source for the program guide. As a result, the video source having many sub-videos may be generated. Here, the H.264 is a recently developed moving picture compression standard to transmit a moving picture with a bandwidth smaller than HD TV, and is referred to as MPEG-4 part 10: advanced video coding (AVC). The H.264 ensures video compressibility enhanced by about 50% compared to conventional MPEG4 in view of bit rates.

In conventional technique, a broadcasting system transmits a mosaic EPG having a limited number of sub-videos through a tool such as a mosaic screen generator. In addition, the broadcasting system should generate different mosaic EPGs in case that sub-videos in the mosaic EPGs are differently arranged.

However, the digital data broadcasting system 100 of the present embodiment generates and encodes the video source having the sub-videos for all available broadcasting programs by using an improved compression technique, and then provides the encoded video source through one channel. Hence, loss of the bandwidth may be reduced when the digital data broadcasting system 100 transmits information for the program guide.

In one example embodiment of the present invention, an application for generation of the program guide is set in the broadcasting terminal 102. Here, the application generates the program guide by editing the video source for the program guide in accordance with audience rating/ranking, and then provides the generated program guide to the user.

As described above, the video source has many sub-videos. It is inefficient to show every sub-video through the program guide.

Accordingly, the broadcasting terminal 102 of the present embodiment performs an editing process of extracting a part of the sub-videos included in the video source through the EPG application, and provides the program guide having the edited sub-video.

The program guide may have constitution shown in FIG. 5 to FIG. 7. As shown in FIG. 5, the program guide of the present embodiment may have band shape. Suitably, sub-videos may be outputted in the order of audience rating/ranking among a plurality of broadcasting programs. For example, the sub-video having the highest audience rating/ranking may be outputted on a center area 500 of a screen initially. In case that the user wants to shift the sub-video through an input apparatus such as a remote controller, the broadcasting terminal 102 may, for example, output in sequence enlarged sub-videos having next highest audience rating/ranking on the center area 500 in an arrow direction as indicated in FIG. 5.

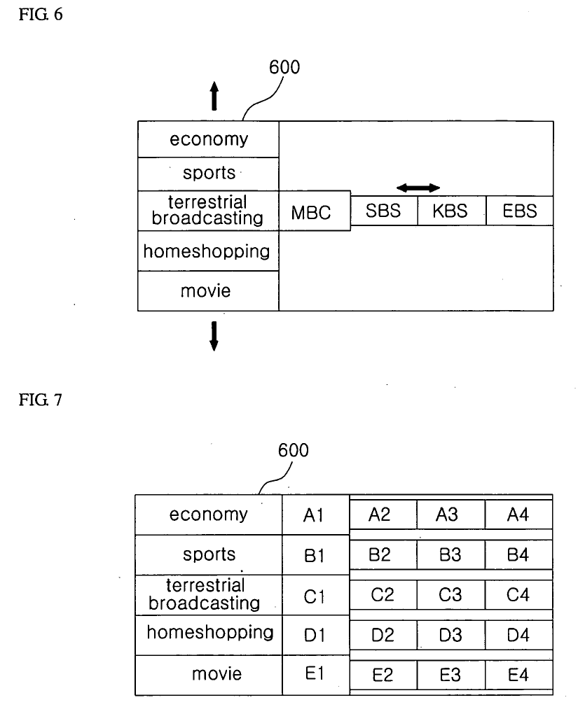

Suitably, the broadcasting terminal 102 may output a program guide having a sub-video corresponding to a preset genre as shown in FIG. 6 and FIG. 7. Here, the broadcasting terminal 102 may output the program guide in which the sub-video of the broadcasting program having the highest audience rating/ranking is shown larger than the sub-videos corresponding to the other genres or the other sub-videos of the broadcasting programs included in the same genre as shown in FIG. 6.

In a non-limiting example, the broadcasting terminal 102 may output the program guide in which the sub-videos having the highest audience rating/ranking of the sub-videos corresponding to each of the genres are outputted on a given area as shown in FIG. 7.

In the program guide shown in FIG. 6 and FIG. 7, in case that other genres other than the genres shown in FIG. 6 and FIG. 7 exist, a genre interface 600 may suitably shift in an up direction or a down direction. Also suitably, the sub-videos may be shifted in a right direction or a left direction.

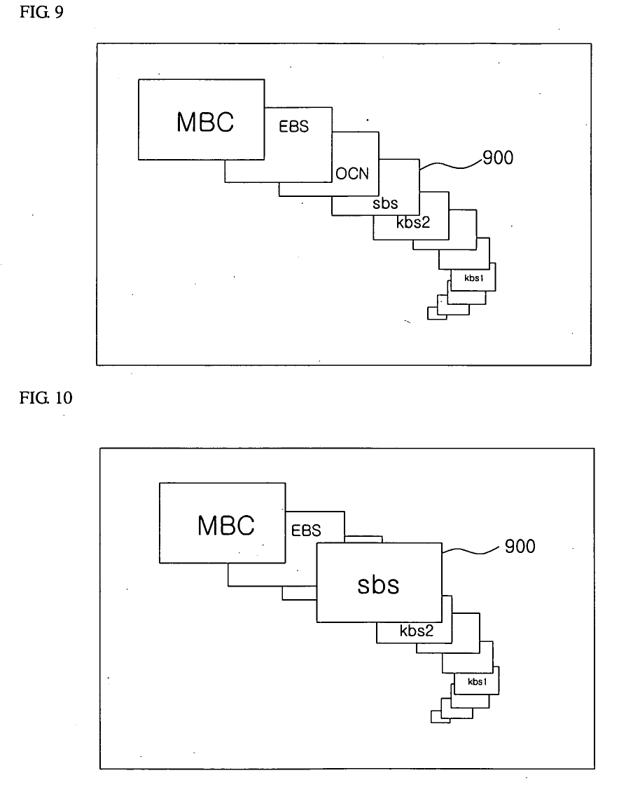

In another example embodiment of the present invention, the broadcasting terminal 102 may output a program guide in which the sizes of the sub-videos differ in accordance with audience rating/ranking. For example, as shown in FIG. 9, in the program guide, the sub-video of a broadcasting program having the highest audience rating/ranking is shown in the largest size at a preset position (e.g., upper left portion), and the other sub-videos are disposed in sequence in accordance with the audience rating/ranking at a preset position. Since the size of the sub-video having the highest audience rating/ranking is greater than that of the sub-video having lower audience rating/ranking, the user may verify intuitively the broadcasting program having the highest audience rating/ranking at present.

In one example embodiment of the present invention, in case that the user searches a channel under the condition that sizes of the sub-videos differ in accordance with the audience rating/ranking, the broadcasting terminal 102 may output a particular sub-video 900 selected by the user in an enlarged size as shown in FIG. 10.

On the other hand, the information concerning the audience rating/ranking may be updated automatically or manually. For example, it can be updated periodically.

To perform the above updating, the broadcasting terminal 102 monitors channel information selected by the user and transmits the monitored information to the digital data broadcasting system 100.

Here, the broadcasting terminal 102 may transmit the channel information with an identifier for identifying the broadcasting terminal 102.

In calculating the audience rating/ranking, it is desirable to count as valid a corresponding channel information to the audience rating/ranking only when the user views the channel for a preset time or longer. Accordingly, the broadcasting terminal 102 may suitably determine whether or not the user has viewed a channel for a preset time or longer after it selects the channel, and then transmit information concerning the viewed channel, i.e. channel information and corresponding identifier, to the digital data broadcasting system 100 in case that the user has viewed for the preset time or longer.

The digital data broadcasting system 100 receives the channel information and the identifiers from the broadcasting terminals 102, and calculates in real time or in a preset period of time the audience rating/ranking about the broadcasting programs.

The digital data broadcasting system 100 transmits information concerning the calculated audience rating/ranking to the broadcasting terminal 102.

The broadcasting terminal 102 provides optimized program guide to the user by using the video source for the program guide and the transmitted information concerning the calculated audience rating/ranking.

In one example embodiment of the present invention, the digital data broadcasting system 100 transmits collective information concerning the sub-videos for the broadcasting programs and the information concerning audience rating/ranking to the broadcasting terminal 102, and the broadcasting terminal 102 generates the program guide. Accordingly, load of the digital data broadcasting system 100 may be reduced. In addition, since the broadcasting terminal 102 stores many sub-videos and generates dynamically the program guide in real time or in the preset period of time in accordance with the audience rating/ranking, a time for generating the program guide may be reduced.

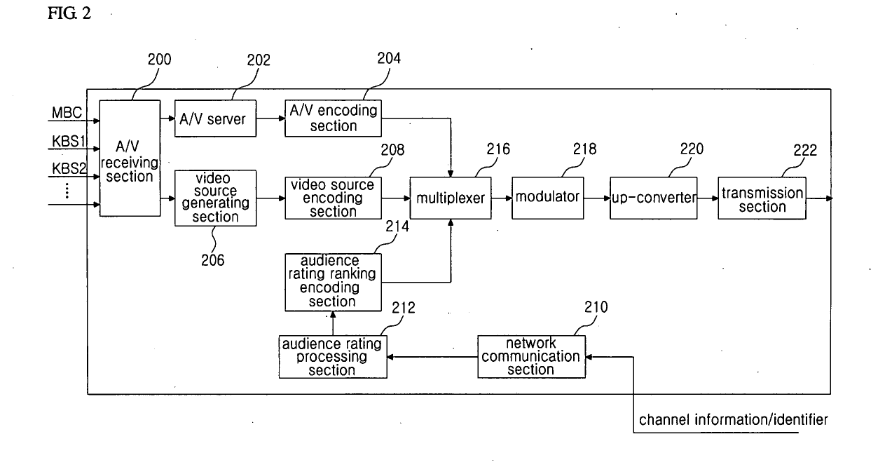

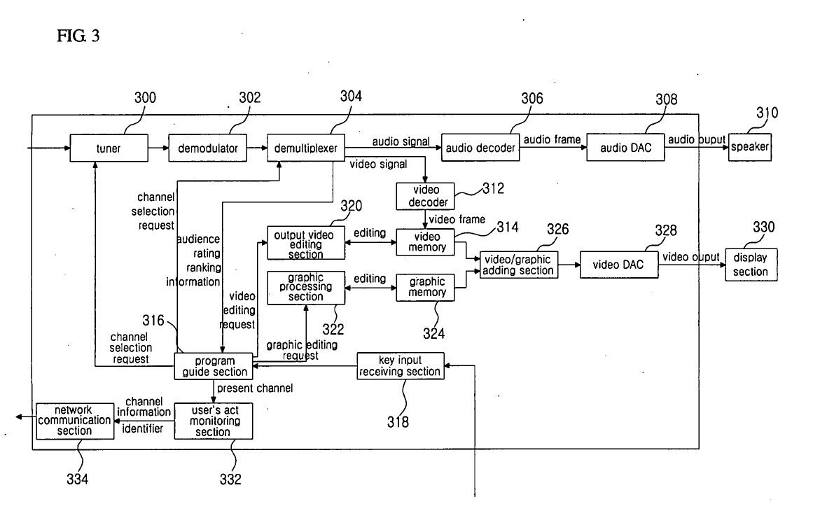

Hereinafter, a process of providing the program guide will be described in detail with reference to accompanying FIG. 2 and FIG. 3.

FIG. 2 is a block diagram illustrating a digital data broadcasting system according to one example embodiment of the present invention.

In FIG. 2, an audio/video A/V receiving section 200 receives a broadcasting signal having an audio signal and a video signal provided from an external broadcasting provider or a terrestrial broadcasting station.

An A/V server 202 collects and manages the transmitted broadcasting signal, and outputs the broadcasting signal to an A/V encoding section 204.

An A/V encoding section 204 converts the received audio signal and the video signal into a predetermined data format. In one example embodiment of the present invention, the A/V encoding section 204 may convert the audio signal and the video signal into a moving picture experts group2-transport stream MPEG2-TS format corresponding to standard of the data broadcasting.

The video signal of the broadcasting signal, which is received by the AIM receiving section 200, is also provided to a video source generating section 206 for the program guide.

The video source generating section 206 generates a plurality of sub-videos for the broadcasting program to be provided by processing the provided video signal. Here, the sub-video is a signal generated by converting the size of the video signal to a small size so that the sub-video is shown on the program guide.

In one example embodiment of the present invention, the video source generating section 206 generates sub-videos for every broadcasting program, and then transmits the generated video source, i.e. sub-videos to a video source encoding section 208.

The video source encoding section 208 encodes the video source of the program guide in accordance with a preset algorithm. For example, it is desirable to encode the sub-videos by using an algorithm in accordance with H.264 compression standard.

The video source encoding section 208 may be embodied as a high definition HD chip set. As a result, the video source encoding section 208 encodes the video source to have high compression efficiency with maintaining high definition.

On the other hand, the digital data broadcasting system 100 provides the information concerning audience rating/ranking to the broadcasting terminal 102 so that the broadcasting terminal 102 can edit the video source for the program guide having many sub-videos.

The network communication section 210 is coupled to the broadcasting terminal 102 through an extra return path which is separate from a broadcasting network, and receives view information of the user from each of the broadcasting terminals 102. Here, the network communication section 210 may receive the view information concerning the channel selected by the user at present and the identifier of the broadcasting terminal 102.

An audience rating processing section 212 processes statistically the view information received from the broadcasting terminals 102, thereby calculating audience rating/ranking. Here, the audience rating processing section 212 may calculate an audience rating/ranking with respect to a particular genre as well as whole audience rating/ranking.

The audience rating processing section 212 may receive individual information of the user, e.g. age, area, sex, etc. from the broadcasting terminal 102, and calculate respectively the audience rating/ranking in accordance with the age, the area and the sex. Here, the individual information of the user is pre-stored in an extra database, and the audience rating processing section 212 may calculate the audience rating/ranking in accordance with the pre-stored individual information.

An audience rating ranking encoding section 214 encodes information concerning the calculated audience rating/ranking.

A multiplexer 216 makes the signals provided from the AIM encoding section 204, the video source encoding section 208 and the audience rating/ranking encoding section 214 into one broadcasting signal to be broadcasted.

A modulator 218 modulates the broadcasting signal in accordance with standard of a broadcasting medium, e.g. terrestrial broadcasting, satellite broadcasting, cable broadcasting.

An up-converter 220 up-converts the modulated broadcasting signal to have a frequency to be transmitted.

A transmission section 222 outputs the up-converted broadcasting signal through the broadcasting medium.

FIG. 3 is a block diagram illustrating a broadcasting terminal according to one example embodiment of the present invention.

As described above, the broadcasting terminal 102 may be a set-top box, coupled to the TV, for providing digital data broadcasting service.

In FIG. 3, a tuner 300 outputs selectively a broadcasting signal of a corresponding channel of the received broadcasting signals with synchronization with a given frequency.

A demodulator 302 demodulates the broadcasting signal outputted from the tuner 300. Here, the demodulated broadcasting signal includes an audio signal, a video signal and data signal, and the demodulator 304 extracts the audio signal, the video signal and the data signal from the demodulated broadcasting signal, and outputs the extracted signals. This may be performed through demuxing and section filtering.

The audio signal outputted from the demultiplexer 304 is decoded by an audio decoder 306. The decoded audio signal is converted into an analog signal through an audio digital analog converter (DAC) 308, and then the converted audio signal is outputted from a speaker 310.

The video signal outputted from the demultiplexer 304 is outputted as video frame not compressed by decoded by a video decoder 312. The video frame is temporarily stored in a video memory 314.

The video memory 314 stores temporarily a still image of the video frame.

A program guide section 316 receives information concerning a present channel selected by the user from a key input receiving section 318.

In accordance with the information concerning the present channel, the program guide section 316 controls the tuner 300 and the demultiplexer 304 so that the tuner 300 and the demultiplexer 304 receive/extract the broadcasting signal for a corresponding channel.

The program guide section 316 receives the information concerning the audience rating/ranking from the demultiplexer 304.

The program guide section 316 requests video editing and graphic editing to an output video editing section 320 and a graphic processing section 322 when the information concerning the audience rating/ranking is received.

The output video editing section 320 performs an editing process such as a process of clipping desired area, a scaling process and a transiting process through the video frame stored temporarily in the video memory 314.

In one example embodiment of the present invention, the video signal outputted from the demultiplexer 304 has sub-video signals for plural broadcasting programs. The output vide editing section 320 performs a process of editing the sub-video or sub-videos included in the video source for the program guide in accordance with the information concerning the received audience rating/ranking. Particularly, the output video editing section 320 may select only a sub-video or sub-videos corresponding to a predetermined audience rating/ranking from the sub-videos of every broadcasting program.

The graphic processing section 322 extracts graphic corresponding to the program guide from a graphic memory 324, and edits the extracted graphic. Here, the graphic may have preset wall paper, etc. outputted with the program guide for selection of the channel.

A video/graphic adding section 326 adds a still image (in a unit of a frame), stored in the video memory 314, i.e. still image of the sub-video frame selected in accordance with the audience rating ranking, to the graphic provided from the graphic memory 324.

A video/graphic generated by the adding is transmitted to a video DAC 328.

The DAC 328 converts the digital video/graphic into an analog signal, and then outputs the converted video/graphic to a display section 330.

The user may verify the program guide shown in FIG. 4 to FIG. 6 through editing request in accordance with the audience rating/ranking and the editing process of the video source in the video editing section 320.

As described above, the program guide includes the sub-video or sub-videos having a given rating/ranking of the sub-videos for every broadcasting program, and specially assists for the user to verify preferentially the sub-video having the highest audience rating/ranking.

A user's act monitoring section 332 receives the present channel information of the user from the program guide section 316, and transmits the present channel information and the identifier of the broadcasting terminal 102 to the network communication section 334. Here, the user's act monitoring section 332 does not transmit simply present channel information inputted in real time to the network communication section 334, but transmits the present channel information to the network communication section 334 in case that the user views the channel for a preset time or longer.

The network communication section 334 transmits the present channel information and the identifier of the broadcasting terminal 102 in a unit of data packet to the digital data broadcasting system 100 through a certain network.

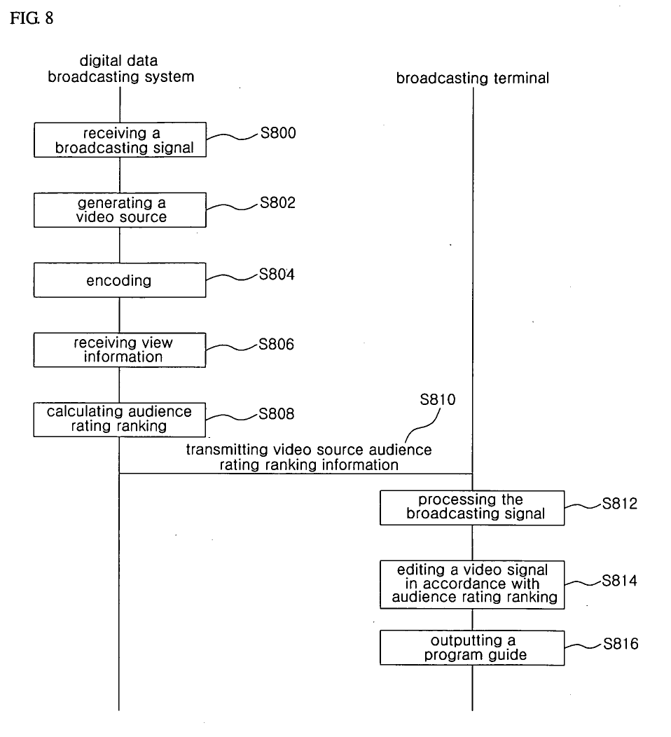

Hereinafter, a process of providing the program guide will be described in detail with reference to accompanying drawing FIG. 8.

In FIG. 8, in step of S800, the digital data broadcasting system 100 receives a broadcasting signal from a terrestrial broadcasting station or a program provider.

In step of S802, the digital data broadcasting system 100 generates a video source for the program guide by processing the video signal for the broadcasting program.

In step of S804, the digital data broadcasting system 100 encodes the video source in accordance with a preset algorithm.

In step of S806, the digital data broadcasting system 100 receives the view information of the user from each of the broadcasting terminals 102. Here, the view information includes the information concerning the present channel selected by the user and the identifier of the broadcasting terminal 102 as described above.

In step of S808, the digital data broadcasting system 100 calculates audience rating/ranking through the view information.

In step of S810, the digital data broadcasting system 100 encodes the information concerning the calculated audience rating/ranking and then transmits the information to the broadcasting terminal 102. Here, information concerning the video source and the information concerning the audience rating/ranking are added as one broadcasting signal, and then the broadcasting signal is transmitted to the broadcasting terminal 102.

In step of S812, the broadcasting terminal 102 extracts the video source for the program guide and the information concerning the audience rating/ranking from the broadcasting signal through the demodulating process and the demuxing process.

In step of S814, the broadcasting terminal 102 performs a video editing process in accordance with the information concerning the audience rating/ranking.

In step of S816, the broadcasting terminal 102 outputs the program guide having only sub-video or sub-videos corresponding to a particular audience rating/ranking of plural sub-videos included in the video source through the above video editing.

In one example embodiment of the present invention, since the digital data broadcasting system 100 provides the video source for the program guide having the sub-videos for every broadcasting program, an extra processing process for the program guide does not need to be performed. In addition, since the broadcasting terminal 102 provides optimized program guide in accordance with the received video source and the audience rating ranking, the user may select easily a channel it wants.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of providing program guide services in a broadcasting system coupled to at least one broadcasting terminal through a network, the method comprising:
generating a video source for a program guide by processing a video signal for at least one broadcasting program;
encoding the video source using a predetermined algorithm; and
transmitting the encoded video source to the broadcasting terminal or terminals,
wherein the broadcasting terminal or terminals output the program guide including at least one of sub-videos included in the video source on the basis of audience rating/ranking.

2. The method of claim 1, wherein the video source includes sub-videos for all of the broadcasting programs that can be provided by the broadcasting system.

3. The method of claim 1, wherein the step of encoding is performed by H.264 compression standard, and the step of transmitting is performed by transmitting the encoded video source through one channel.

4. The method of claim 1, further comprising:
receiving view information of a user or users from the broadcasting terminal or terminals;
calculating audience rating/ranking by using the received view information; and
transmitting information concerning the calculated audience rating/ranking periodically to the broadcasting terminal or terminals.

5. The method of claim 4, wherein the view information includes information about channel or channels currently viewed by the user or users.

6. The method of claim 4, wherein the broadcasting terminal or terminals transmit the view information to the broadcasting system when the user or users view the channel or channels for a predetermined time or longer.

7. The method of claim 1, wherein the broadcasting terminal or terminals output, in a larger size, a sub-video or sub-videos of the broadcasting program having the highest audience rating/ranking than those having lower audience rating/ranking.

8. The method of claim 7, wherein the audience rating/ranking is provided with respect to preset genres, and the broadcasting terminal or terminals output, in a larger size, the sub-video or sub-videos of the broadcasting program having the highest audience rating/ranking in each of the genres.

9. The method of claim 7, wherein the broadcasting terminal or terminals output the sub-videos with different sizes in accordance with the audience rating/ranking.

10. The method of claim 9, wherein the broadcasting terminal or terminals output the sub-video or sub-videos selected by the user or users in a larger size.

11. A system for providing broadcasting services to at least one broadcasting terminal through a network, the system comprising:
a video source generating section configured to generate a video source for a program guide by processing a video signal for at least one broadcasting program;
a video source encoding section configured to encode the video source using a preset algorithm;
an audience rating/ranking processing section configured to calculate audience rating/ranking through view information of a user or users transmitted from the broadcasting terminal or terminals; and
an audience rating/ranking encoding section configured to encode information concerning the calculated audience rating ranking,
wherein the broadcasting terminal or terminals output the program guide including at least one of sub-videos included in the video source on the basis of the information concerning the audience rating/ranking.

12. The system of claim 11, wherein the video source generating section generates the video source for all of the broadcasting programs that can be provided by the broadcasting system, and the video source encoding section encodes the video source to a file in accordance with H.264 compression standard.

13. A method of providing program guide services to a broadcasting terminal which receives a broadcasting program from a broadcasting system through a network and displays the broadcasting program, the method comprising:
receiving a video source for a program guide and information concerning audience rating/ranking, wherein the video source includes a plurality of sub-videos for plural broadcasting programs and is encoded in accordance with a preset algorithm;
editing the sub-videos included in the video source by using the information concerning the audience rating/ranking; and
generating the program guide including at least one of the edited sub-videos.

14. The method of claim 13, further comprising:
monitoring present channel information through key signal input of a user; and
transmitting the present channel information to the broadcasting system through the network.

15. The method of claim 14, wherein the step of monitoring includes determining whether or not the user views the channel for a predetermined time or longer.

16. The method of claim 13, wherein the video source includes a video signal for all of the broadcasting programs that can be provided by the broadcasting system, the step of generating the program guide is performed by generating the program guide which includes a sub-video or sub-videos of a broadcasting program having the highest audience rating/ranking with respect to each of preset genres.

17. The method of claim 13, wherein the sub-videos are outputted in different sizes in accordance with the audience rating/ranking.

18. The method of claim 17, wherein a sub-video selected by the user is outputted in a larger size.

19. The method of claim 13, wherein the video source includes sub-videos for all of the broadcasting programs that can be provided by the broadcasting system.

20. The method of claim 13, wherein the video source is encoded in accordance with H.264 compression standard.
